(19) United States
(12) Patent Application Publication
(10) Pub. No.: US 2025/0325925 A1
(43) Pub. Date: Oct. 23, 2025

(54) DRAINAGE APPARATUS AND METHOD FOR MATERIAL CLEANING AND DEWATERING

(71) Applicant: ABT, INC., Troutman, NC (US)

(72) Inventors: George William Bancroft, Troutman, NC (US); Jennifer Cecile Seuss, Salisbury, NC (US); Tom Simon, Troutman, NC (US)

(73) Assignee: ABT, INC., Troutman, NC (US)

(21) Appl. No.: 18/860,572

(22) PCT Filed: Apr. 25, 2023
(86) PCT No.: PCT/US2023/019802

§ 371 Date: Oct. 25, 2024

Related U.S. Application Data
(60) Provisional application No. 63/334,306, filed on Apr. 25, 2022.

(51) Int. Cl. B01D 29/03; B01D 29/01; B01D 37/00; B01D 39/20; E01C 11/22; E03F 1/00

(52) U.S. Cl. CPC B01D 29/03; B01D 29/012; B01D 37/00; B01D 39/2072; E03F 1/00; B01D 2239/10; E01C 11/224

(57) ABSTRACT

A drainage apparatus for material cleaning and dewatering, the apparatus comprising one or more void structures, wherein the one or more void structures comprises a plurality of apertures configured to allow liquid to permeate the one or more void structures and one or more structural apertures, one or more columns, wherein the one or more columns are defined by the one or more structural apertures and a wear surface having a first side and a second side of the wear surface, wherein the first side of the wear surface is positioned proximate the one or more columns and the second side of the wear surface is positioned proximate a work product.

### FIELD OF THE INVENTION

The present invention relates to a drainage apparatus and method for cleaning and dewatering byproducts of excavation, construction, mining operations, or the like.

### BACKGROUND

Currently, several methods and apparatuses exist for separating liquid from solid particles (hereinafter “dewatering”), including surface pumping with or without rim ditches, and pre-drainage with wellpoint, deep well, or horizontal drain systems. Most rely on labor-intensive construction and excavation along with multiple layers of various sized infill materials such as stone in conjunction with geo-textile fabrics to transport and decant the liquid. As such, there is a need for a drainage apparatus and method for material cleaning and dewatering.

### BRIEF DESCRIPTION OF THE DRAWINGS

Having thus described embodiments of the invention in general terms, reference will now be made to the accompanying drawings, wherein:

FIG. 1 is a side elevation view of a drainage apparatus for material cleaning and dewatering, according to some embodiments of the present invention;

FIG. 2 is a cross section view A-A of a drainage apparatus for material cleaning and dewatering, according to the embodiment in FIG. 1;

FIG. 3A is a side elevation view of a drainage apparatus for material cleaning and dewatering, according to some embodiments of the present invention;

FIG. 3B is a side elevation view of a drainage apparatus for material cleaning and dewatering, according to some embodiments of the present invention; and

FIG. 4 illustrates a drain system environment in which the apparatuses and processes described herein are implemented, according to embodiments of the present invention;

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Additionally, certain terminology is used herein for convenience only and is not to be interpreted as a limitation on the embodiments described. For example, the words “top,” “bottom,” “upper,” “lower,” “left,” “right,” “horizontal,” “vertical,” “upward,” and “downward” merely describe the configurations as depicted in the figures. Indeed, the referenced components in the figures may be oriented in any direction, unless specified otherwise, the configurative terminology used herein should be understood as encompassing such variations.

Embodiments of the invention are directed to a drainage apparatus and method for material cleaning and dewatering. The apparatus and method allow for liquid to be removed from sediment, dirt, sand, rocks, or the like.

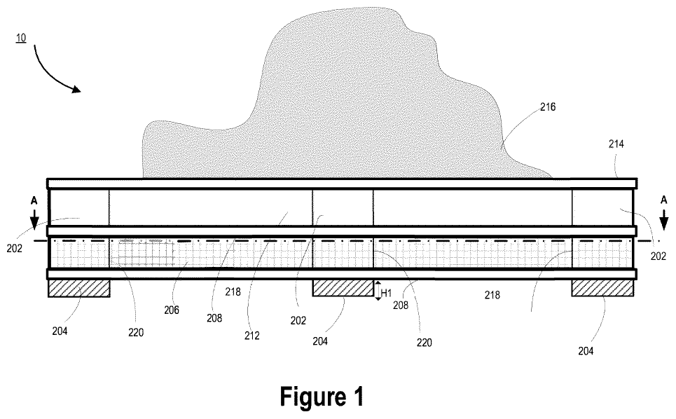

FIG. 1 illustrates a side elevation view of drainage apparatus 10 in accordance with some embodiments of the invention. It shall be noted that void structure 206 and infill 212 are depicted graphically in FIG. 1 as translucent in order to fully describe the embodiment. As illustrated in FIG. 1, a drainage apparatus 10 is constructed in the ground or existing surface structure (e.g., dirt, cement, concrete, asphalt, pavement, tarmac, roadway, sand, or the like). The apparatus may be constructed entirely sub-ground surface, such that the drainage apparatus 10 sits below the surface. The ground may be removed from the vicinity of the drainage apparatus 10 prior to installation by use of an excavator, trencher, backhoe, or the like. In some embodiments, drainage apparatus 10 may be constructed such that parts or whole of the drainage apparatus 10 are exposed above the ground surface after installation. Nonetheless, piers 204 are positioned at the bottom of the drainage apparatus such that piers 204 provide support and leveling to the remainder of the structure. Piers 204 may be comprised of cementitious materials, cement, concrete, rebar, metal, asphalt, polymers, coarse or fine aggregate, or the like. Piers 204 may be comprised of any combination of construction materials known to provide structural support. In some embodiments of the described herein, piers 204 may not be necessary for the drainage apparatus and may be omitted provided there is sufficient support in the ground surface. In some embodiments, piers 204 may be molded or formed in-place at the site of the ground surface, such as to avoid challenges associated with transportation of such piers 204.

Piers 204 are positioned relative to the rest of the drainage apparatus 20 such that a void 218 with height H1 is formed. In some embodiments, the height H1 is sufficient to position equipment, filters, collection devices, or the like within height H1. However, in other embodiments, height H1 may be close to or equal to zero, such that liner 208 and/or void structure 206 are positioned proximate the ground surface at the bottom of a trench. Void 218 may serve as a location where which liquid removed from work product 216 by drainage apparatus 20 may collect. Work product 216 may comprise soil, tailings, ore, rocks, sediment, sludge, or any material of which liquid needs to be removed (“WIP”). Work product 216 is positioned on top of the drainage apparatus such that gravity and/or pumps may move and filter liquid from work product 216 through implementation of the drainage apparatus 20.

Columns 202 may be comprised of cementitious materials, cement, concrete, metal, rebar, asphalt, polymers, coarse or fine aggregate, or the like. Columns 202 may be comprised of any combination of construction materials known to provide structural support. As will be explained in greater detail herein, columns 202 may be molded or formed in-place at the site of the ground surface, such as to avoid challenges associated with transportation of such columns 202.

Positioned proximate to each pier is void structure 206. Void structure 206 is a device having structure and voids for collecting and dewatering liquids (such as water) from material such that the liquid may be recycled, processed, stored evaporated, or the like. Void structure 206 may comprise a rigid or semi-rigid material configured in approximately a rectangular cuboid overall outer shape and further configured with apertures to allow liquid to freely permeate the void structure 206. Void structure 206 comprises substantially parallel top and bottom walls joined by side walls defining an enclosed volume. The overall outer shape of void structure 206 is cuboid in nature, but in some embodiments the overall outer shape of void structure 206 may be rectangular cuboid, square cuboid, or the like.

Each void structure 206 may be configured to connect to additional void structures to form an array of void structures 206, each void structure 206 connected to the other with one or more mechanical fastening or interconnectivity devices. Within the enclosed volume of each void structure 206 is a plurality of bracing members and a plurality of stiffening arms extending between each bracing member, such that the void structure 206 resists flexural stresses or permanent and/or temporary deformation along any direction when subjected to external forces from equipment, work product 216, human movement, or the like.

Each wall of the void structure 206 comprises a plurality of apertures configured to allow liquid to pass with ease and furthermore prevent large objects from entering the internal void(s) of the void structure 206. In some embodiments, the plurality of apertures may be rectangular. In other embodiments, the plurality of apertures may be circular. Depending on the application of void structure 206, additional variations in aperture shape and geometry may be used, such as triangles, ovals, or the like.

As previously described, columns 202 are often molded or formed in-place. Columns 202 are typically formed by aligning like-sized apertures known as structural apertures 220 in void structures 206, such that when one or more void structures 206 are positioned relative to the ground surface at locations which void structures 206 will be permanently or semi-permanently positioned, the material comprising columns 202 is inserted into the structural apertures 220. Structural apertures 220 are positioned such that when a first void structure 206 is positioned above a second void structure 206, the structural apertures 220 align respective to each void structure 206, forming a column-shaped void continuous in the vertical direction to both the first void structure 206 and the second void shaped structure 206. Material is applied to the column-shaped void as a liquid or semi-solid state to form columns 202. The material is then allowed to harden to form a rigid column 202. In some embodiments, the column-shaped voids may be vertically continuous between one or more void structures 206. In other embodiments, the column 202 may be intended to be a fixed length, such that that column 202 is formed in a short length between one or more void structures 206, and a subsequent column 202 is formed adjacent to the pre-existing column 202. Although discontinuous and discrete in nature, these shorter separate columns 202 may provide the structural support necessary for the application. In some embodiments, columns 202 may be pre-formed and inserted into the structural apertures in a solid state.

In some embodiments, structural apertures 220 are inherent to the design of void structure 206, such that the void apertures 220 are molded or formed during the manufacturing process of void structure 206. In other embodiments, existing void structures 206 may be subjected to any number of post-processing operations to create void apertures 220, such as machining, milling, cutting, plasma-cutting, grinding, and so forth. Notwithstanding, the shape of void apertures 206 may be any number of geometric shapes such as squares, circles, triangles, or the like. As such, the end result of the column 202 formation process may result in cylindrical columns 202, rectangular cuboid columns 202, triangular columns 202, etc.

In some embodiments, void structure 206 may be configured to accept infill media within the voids of void structure 206, such as chemical or biological treatment media, to treat, decontaminate, or sterilize any liquid which passes over/through the infill media.

In some embodiments, void structure 206 may be comprised of a polymer or plastic material formed. In other embodiments, it may be beneficial to form void structure 206 out of an alternate material such as concrete, steel, rubber, wood, carbon fiber, or the like. In this way, any material may be used which is found to provide the appropriate liquid-carrying properties through the apertures while still maintaining geometric stability. It shall be considered that the application of void structure 206 is within a ground surface, and as such the material should not typically be biodegradable. However, in some embodiments for temporary usage, a biodegradable material may be preferred, as to avoid costly removal from the ground surface at a later date.

It shall be noted that although FIG. 1 depicts a singular void structure 206, many embodiments of the invention comprise a plurality of void structures, as previously described. Specifically, there may be a plurality of void structures 206 stacked in the vertical direction. Each layer of void structures 206 may be configured to connect to additional void structures to form an array of void structures 206, each void structure 206 connected to the other with one or more mechanical fastening or interconnectivity devices. Void structures 206 may also comprise nesting or latching features, such that each layer of void structure 206 may be structured to sit within adjacent void structures 206 and form a semi-structural, but releasable formation to prevent lateral movement among the void structures 206.

Void structure 206 may be enclosed on the left, right, front, or back sides by liner 208. In some embodiments, liner 208 may also be positioned below void structure 206. Liner 208 is configured such that excess liquid removed from work product 216 is directed primarily to the void structure 206. As such, liner 208 may be comprised of a waterproof polymer or plastic material impervious to liquid. In some embodiments, however, liner 208 may comprise a textile material so allow some liquid to pass through liner 208. In some embodiments, liner 208 may not be required for drainage apparatus 20 to function properly and may be omitted altogether. In some embodiments, liner 208 may comprise side panels configured to releasably attach to the void structure 206. Furthermore, in some embodiments, liner 208 may be positioned along the entire underside of the ground surface and/or each of the sides of the ground surface, such that void structure 206, columns 202, and piers 204 (or any combination thereof) are all positioned above a continuous or partially-continuous liner 208, such that minimal amount of ground surface is exposed to any liquid.

Positioned above void structure 206 is geotextile 214, wherein the geotextile comprises a permeable material such as a textile or polymer, with apertures sufficient to allow liquid to permeate the geotextile 214 while retaining and/or removing larger sediment or rocks/stones from the material which is dewatered. Above the geotextile 214 is a layer of infill 212. Infill 212 may comprise stones, rocks, pebbles, polymer-based objects, sand, or the like. Infill 212 serves to remove and/or prevent large objects from the work product 216 from entering geotextile 214 or void structure 206. The size of infill 212 may be contemplated based on the type of work product 216, the rate of which dewatering/cleaning is to be performed, or the like. In some embodiments, there may not be a desire to utilize infill 212, and as such infill 212 may not be present in drainage apparatus 10. In this way, void structure 206 may be extended to encompass the volume of area depicted as shown by infill 212 graphically. In some embodiments, the void created by lack of addition of infill 212 may remain empty, such that an air pocket remains. Positioned on top of infill 212 is wear surface 214. In some embodiments, wear surface 214 is positioned to span between columns 202, such that columns 202 provide the support structure. Wear surface 214 is positioned directly beneath work product 216, and as such, wear surface 214 must be configured to withstand forces and pressures applied to wear surface 214 by work product 216, equipment at the worksite, pedestrian traffic, or the like. Wear surface 214 may comprise a plurality of apertures, or in some embodiments, spaces between adjacent wear surfaces. The apertures or spaces are sized appropriately to allow for liquid, and in some cases work product 216, to permeate wear surface 214. Wear surface 214 may be comprised of metal, plastic, concrete, fibrous material, wood, bricks, pavers, or the like.

Wear surface 214, infill 212, void structure 206, liner 208, and geotextile 214 may each be configured to accept an array of tools, inspection systems, material or liquid handling systems to be used in conjunction with the apparatus for material cleaning and dewatering, including but not limited to risers for visual inspection, pumps, access units comprising knockouts for pipe compatibility, floating aeration devices, pipes, top side rinse connections, trench anchors, remote cameras, heaters, air dryers, air compressors, oil/water separators, vents, or the like.

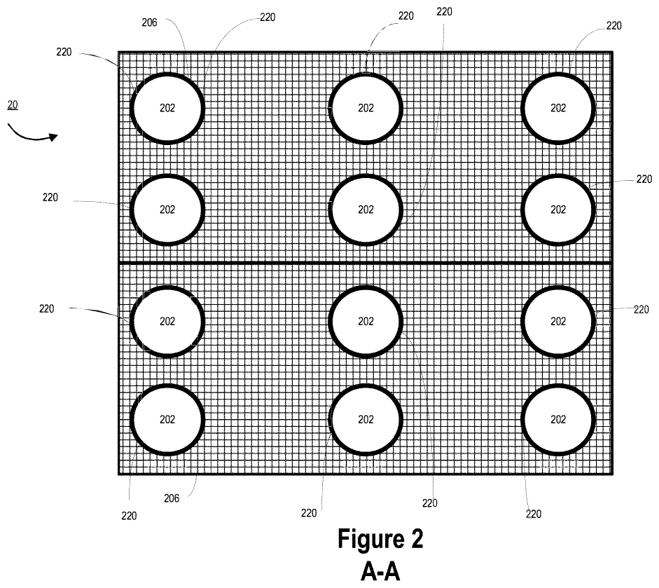

FIG. 2 illustrates a cross-sectional view A-A of the embodiment described in FIG. 1. A non-limiting example of an array of void structures 206 is shown, wherein each void structure 206 comprises a plurality of columns 202 and structural apertures 220.

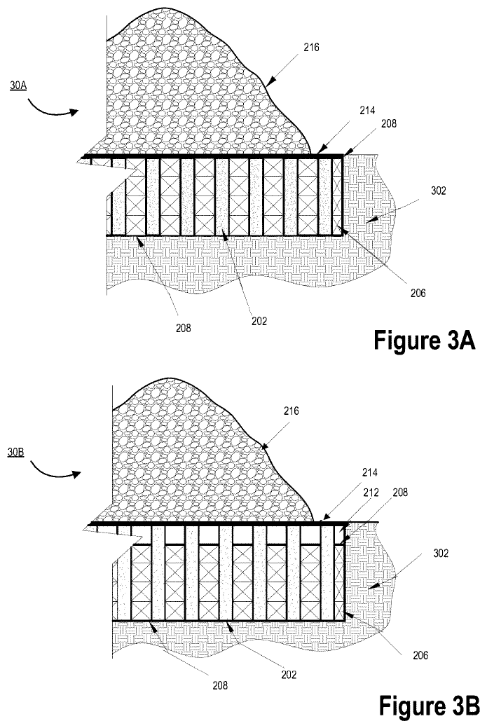

FIG. 3A illustrates a side elevation view of drainage apparatus 30A in accordance with another embodiment of the invention. It shall be noted that all components of drainage apparatus 30A function similarly to those which are described above in FIGS. 1 and 2. However, this embodiment does not comprise piers 204. In this embodiment, drainage apparatus 30A is shown within ground surface 302, such that the wear surface 214 is flush with the top portion of ground surface 302. It shall also be known that in this embodiment, liner 208 is depicted as covering only the top and bottom portions of void structure 206. As previously described, the placement of liner 208 is dependent on a variety of factors, including but not limited to: type of liquid being processed, environment, components of ground surface 302, drainage direction, and so forth.

FIG. 3B illustrates a side elevation view of drainage apparatus 30B in accordance with another embodiment of the invention. It shall be noted that all components of drainage apparatus 30B function similarly to those which are described above in FIG. 3A. Similarly, in this embodiment, drainage apparatus 30B is shown within ground surface 302, such that the wear surface 214 is flush with the top portion of ground surface 302. However, this embodiment does not comprise piers 204, nor does it comprise infill 212.

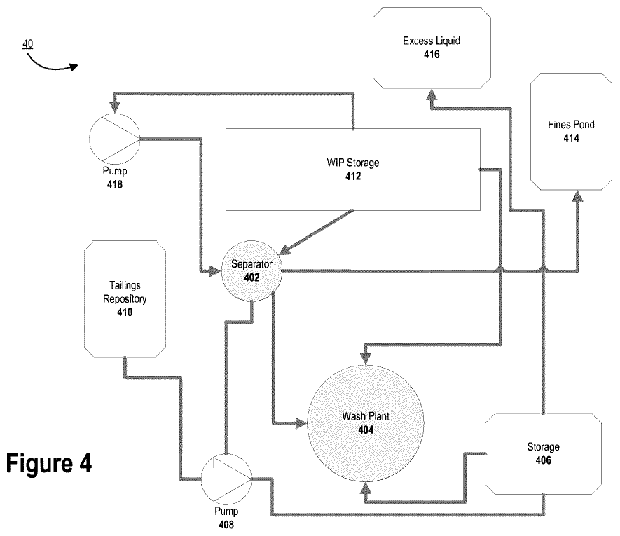

FIG. 4 illustrates a block diagram of a worksite operation 40, wherein the drainage apparatus for material cleaning and dewatering may be utilized. Arrows on FIG. 4 depict a non-limiting example of flow direction of material, liquid, or the combinations thereof. Connectors in FIG. 4 without arrows indicate, in this non-limiting example, bi-directional flow. WIP storage 412 may be operatively coupled to separator 402 and pump 418, wherein separator 402 may be an oil/liquid or oil/water separator. Separator 402 may be operatively coupled to wash plant 404, pump 418, fines pond 414, and pump 408. Pump 408 may be operatively coupled to tailings repository 410 and storage 406. Storage 406 may be operatively coupled to wash plant 404 and excess liquid 416.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A drainage apparatus for material cleaning and dewatering, the apparatus comprising:
one or more void structures, wherein the one or more void structures comprises:
a plurality of apertures configured to allow liquid to permeate the one or more void structures; and
one or more structural apertures;
one or more columns, wherein the one or more columns are defined by the one or more structural apertures; and
a wear surface having a first side and a second side of the wear surface, wherein the first side of the wear surface is positioned proximate the one or more columns and the second side of the wear surface is positioned proximate a work product.

2. A method for forming a drainage apparatus, the method comprising:
positioning one or more void structures at a ground surface, the one or more void structures each having a first side and a second side, and wherein the one or more structural apertures extend from the first side to the second side;
stacking the one or more void structures such that the one or more structural apertures are aligned for the void structures, wherein the structural apertures define a void; and
applying a cementitious mixture to the void.

3. A method for material cleaning and dewatering, the method comprising:
providing a work product to a wear surface comprising one or more apertures, wherein the work product comprises a liquid;
moving the liquid from the work product through one or more apertures in the wear surface;
moving the liquid through one or more void structures, wherein the one or more void structures comprises a plurality of apertures configured to allow liquid to permeate the one or more void structures; and
collecting the liquid from a location external to the one or more void structures.
